(19) United States
(12) Patent Application Publication
(10) Pub. No.: US 2009/0158386 A1
(43) Pub. Date: Jun. 18, 2009

(54) METHOD AND APPARATUS FOR CHECKING FIREWALL POLICY

(76) Inventor: Sang Hun LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/249,022

(22) Filed: Oct. 10, 2008

(30) Foreign Application Priority Data
Dec. 17, 2007 (KR) 10-2007-0132750
Sep. 11, 2008 (KR) 10-2008-0089981

(51) Int. Cl. G06F 21/00

(52) U.S. Cl. 726/1

(57) ABSTRACT

A method and apparatus for checking for vulnerabilities in a firewall policy used in a firewall system are provided. The method includes determining whether a target firewall policy is for an existing firewall system or a new firewall system, when the target firewall policy is for the existing firewall system, checking for errors in the target firewall policy by comparing the target firewall policy with an existing firewall policy applied to the existing firewall system, and when the target firewall policy is for the new firewall system, checking for errors in the target firewall policy by simulating a state in which the target firewall policy is applied to the new firewall system.

### CROSS-REFERENCE TO RELATED APPLICATION

This application claims priority to and the benefit of Korean Patent Application Nos. 2007-132750, filed Dec. 17, 2007 and 2008-89981, filed Sep. 11, 2008, the disclosures of which are incorporated herein by reference in their entirety.

### BACKGROUND

1. Field of the Invention

The present invention relates to network security technology, and more particularly, to a method and apparatus for checking for vulnerabilities in a firewall policy used in a firewall system.

2. Discussion of Related Art

Currently, due to the spread of high-speed networks and the Internet, web servers providing services through the Internet are also rapidly developing. The appearance of the web has activated new functions such as methods of doing business and methods of retrieving information. Companies operate their own homepages to promote their products, and even ordinary Internet users operate their own homepages. In this way, the Internet has become popular and common in day-to-day life.

However, the growth and popularization of the Internet has been accompanied by advances in hacking technology using vulnerabilities of web servers. Specifically, as a number of web servers have vulnerabilities due to faulty implementation of a Common Gateway Interface (CGI) or the like, they have become a main attack target of hackers.

As hacking technology becomes more advanced due to the ongoing development of network technology, anti-hacking technology, that is, technology associated with a firewall system, is also developing. The development of firewall system technology has significantly improved the security of computing systems. Moreover, a manager can alleviate the difficulty in managing all the individual systems, and instead manage systems by the network. Accordingly, the task of the manager has been made easier, and mistakes in system management have been also reduced.

However, as a network grows and gets divided, the configuration of the firewall system becomes more complex and diversified and thus the firewall system manager is liable to make more mistakes when setting a firewall policy in the firewall system. Also, due to vulnerability caused by managerial setting errors, many networks are being attacked by hackers.

Further, when a firewall system policy is checked, the checking is manually performed and thus there may be a firewall policy that includes vulnerabilities caused by mistakes made by an inspector. However, there is no method for checking the firewall policy.

Accordingly, in order to more effectively check a firewall policy set in a firewall system, there is a need for a method of performing such a check automatically.

### SUMMARY OF THE INVENTION

The present invention is directed to a method and apparatus that can automatically check for setting errors in a firewall policy used in a firewall system.

The present invention is also directed to a method and apparatus that can automatically check for vulnerabilities in a firewall policy which is applied or will be applied in an existing firewall system or will be newly activated.

Additional purposes of the present invention can be understood from the description which follows.

One aspect of the present invention provides a method of checking a firewall policy, the method comprising: determining whether a target firewall policy is for an existing firewall system or a new firewall system; when the target firewall policy is for the existing firewall system, checking for errors in the target firewall policy by comparing the target firewall policy with an existing firewall policy applied to the existing firewall system; and when the target firewall policy is for the new firewall system, checking for errors in the target firewall policy by simulating a state in which the target firewall policy is applied to the new firewall system.

Another aspect of the present invention provides an apparatus for checking a firewall policy, the apparatus comprising: a firewall policy receiving unit that receives a target firewall policy; a checking unit that checks for errors in the target firewall policy by comparing the target firewall policy with an existing firewall policy applied to an existing firewall system; and a check result output unit that outputs the results of the checking process.

### BRIEF DESCRIPTION OF THE DRAWINGS

The above and other features and advantages of the present invention will become more apparent to those of ordinary skill in the art by describing in detail preferred embodiments thereof with reference to the attached drawings, in which:

FIG. 1 is a block diagram of a firewall policy checking apparatus according to an embodiment of the present invention; and

FIG. 2 is a flowchart illustrating a method of checking for vulnerabilities in a firewall policy according to an embodiment of the present invention.

### DETAILED DESCRIPTION OF EXEMPLARY EMBODIMENTS

Functions or configurations related to the invention that are already known among those skilled in the art will not be described in detail to keep this disclosure concise. Further, some terms used herein have been chosen for their functional descriptiveness and may be changed by users, operators or according to customs.

A firewall policy checking apparatus disclosed in the present invention may be installed at a position that is physically separated from a firewall system in order not to affect operation of the firewall system. Further, the firewall policy checking apparatus has a structure for receiving a firewall policy of the firewall system to check for vulnerabilities in the firewall policy.

Specifically, the firewall policy checking apparatus according to an exemplary embodiment of the present invention receives a firewall policy from a manager or a firewall system, checks for vulnerabilities caused by setting errors, and reports the results to the manager.

Hereinafter, exemplary embodiments of the present invention will be described in detail with reference to the accompanying drawings.

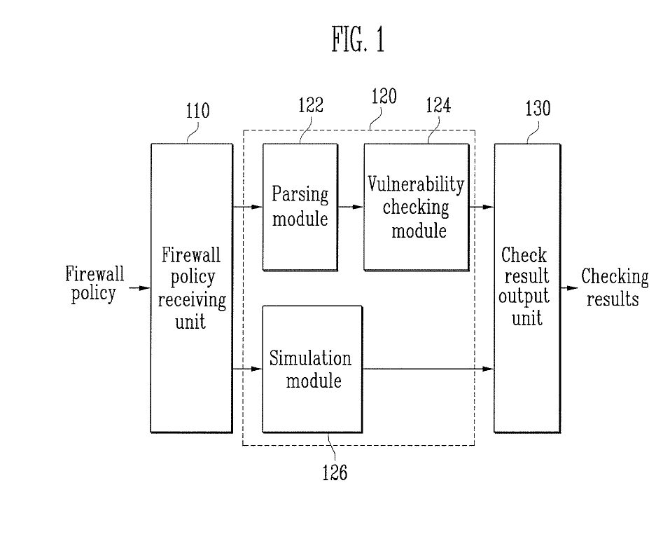

FIG. 1 is a block diagram of a firewall policy checking apparatus according to an exemplary embodiment of the present invention. Referring to FIG. 1, the firewall policy checking apparatus includes a firewall policy receiving unit 110, a checking unit 120, and a check result output unit 130.

The firewall policy receiving unit 110 receives a firewall policy applied to an existing firewall system or a new firewall system that has yet to be activated. The firewall policy may be directly input by a manager. In another exemplary embodiment, the firewall policy receiving unit 110 may periodically collect an existing firewall policy from the existing firewall system.

The checking unit 120 includes a parsing module 122, a vulnerability checking module 124, and a simulation module 126, in order to check a setting error of the firewall policy received by the firewall policy receiving unit 110.

When the firewall policy received by the firewall policy receiving unit 110 is to be applied to an existing firewall system, the parsing module 122 parses the firewall policy and then outputs it in a form that can be compared with an existing firewall policy.

The vulnerability checking module 124 compares the parsed firewall policy with the existing firewall policy which has been already applied to the firewall system, thereby checking for setting errors in the firewall policy.

For example, let it be assumed that a firewall policy of “start IP: 10.10.10.*, destination IP: any, protocol: any, policy: deny” is already applied to the existing firewall system. Thereafter, when a new firewall policy of “start IP: 10.10.10.100, destination IP: 200.10.10.*, protocol: any, policy: allow” is input, it is determined that a setting error exists in the new firewall policy, because it includes “policy: allow” which conflicts with “policy: deny” of the existing firewall policy.

When the firewall policy is to be applied to a new firewall system that has yet to be activated, the simulation module 126 simulates a state in which the firewall policy is applied to the new firewall system, thereby checking for vulnerabilities in the firewall policy.

For example, let it be assumed that a new firewall system is to be activated and will protect a web server by allowing only port 80 (http protocol service) for packets transmitted from outside. When a firewall policy (1) of ‘start IP: any, destination IP: web server zone, protocol: http, port: 80, policy: allow’, a firewall policy (2) of ‘start IP: web server zone, destination IP: any, protocol: http, port: 80, policy: allow’, and a firewall policy (3) of ‘start IP: any, destination IP: any, protocol: http, port: 25, policy: allow’ are to be applied, the simulation module 126 performs a simulation by applying policies (1) to (3) to the new firewall system.

As a result of the simulation, the simulation module 126 determines that policies (1) and (2) for allowing port 80 to provide the http web service coincide with the purpose of the firewall system. On the other hand, the simulation module 126 determines that the policy (3) conflicts with the original purpose of the firewall system, because it allows port 25.

The check result output unit 130 outputs to the manager results provided from the vulnerability checking module 124 and the simulation module 126. The check result output unit 130 may output the results through a Graphic User Interface (GUI) for the manager to readily recognize.

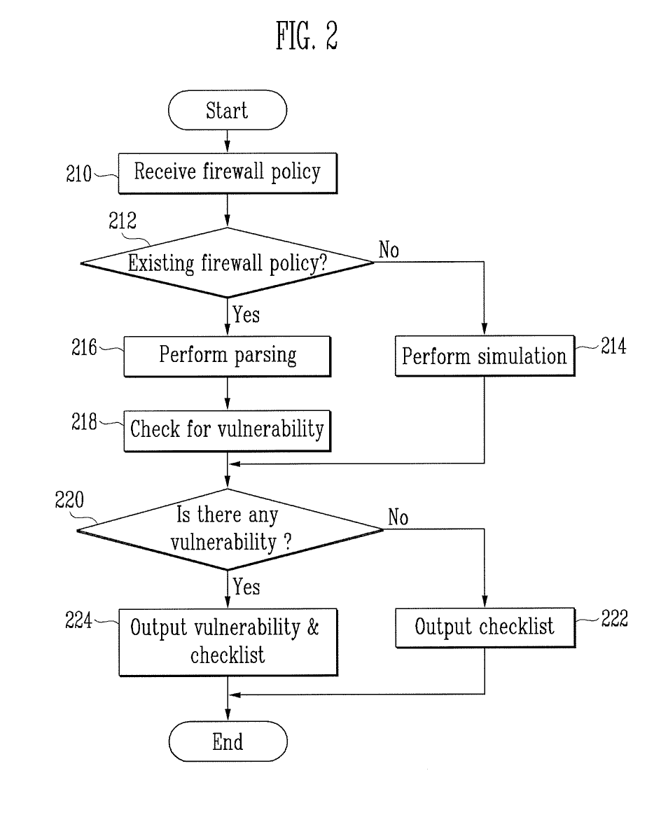

FIG. 2 is a flowchart illustrating a method of checking for vulnerabilities in a firewall policy according to an exemplary embodiment of the present invention.

In step 210, a firewall policy is received. The firewall policy may be used or intended to be used in an existing firewall system or intended to be used in a new firewall system that has yet to be activated.

The firewall policy may be received from a manager, and particularly, the existing firewall policy may be received from the firewall system. The existing firewall policy may be periodically received from the firewall system.

In step 212, it is determined whether the received firewall policy is to be used in an existing firewall system or a new firewall system that has yet to be activated.

When it is determined that the received firewall policy is to be used in a new firewall system, a state in which the received firewall policy is applied to the new firewall system is simulated (step 214). The new firewall system is clearly defined up to a protocol level (for example, tcp, udp) based on its purpose and the simulation of applying the firewall policy to the system is then performed to check whether inaccessible systems are reliably blocked or not.

When it is determined that the received firewall policy is to be used in an existing firewall system, it is parsed into a form that allows it to be checked for the vulnerability.

In step S218, the vulnerability caused by setting errors in the received firewall policy is checked based on the parsing result. The vulnerability checking is performed by comparing the parsed policy with existing firewall policies that have already been used in the existing firewall system.

In step 222, when it is checked that there is no vulnerability in the firewall policy, the checking result is output to the manger.

In step 224, when it is checked that there is vulnerability in the firewall policy, the checklist and the vulnerability are output to the manager. In this case, the vulnerability in the firewall policy may be displayed via a GUI that the manager can easily readily recognize.

According to the present invention, setting errors in the firewall policy that is or will be applied to an existing firewall system or a new firewall system are automatically detected and reported to a manager. This makes it possible to provide a stable operating environment for the firewall system.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of checking a firewall policy, the method comprising:
determining whether a target firewall policy is for an existing firewall system or a new firewall system;
when the target firewall policy is for the existing firewall system, checking for errors in the target firewall policy by comparing the target firewall policy with an existing firewall policy applied to the existing firewall system; and
when the target firewall policy is for the new firewall system, checking for errors in the target firewall policy by simulating a state in which the target firewall policy is applied to the new firewall system.

2. The method of claim 1, further comprising:
periodically receiving the target firewall policy from the existing firewall system.

3. The method of claim 1, further comprising:
receiving the target firewall policy from a user.

4. The method of claim 1, further comprising:
when the target firewall policy is for the existing firewall system, parsing the target firewall policy to convert it into a form that can be compared with the existing firewall policy.

5. The method of claim 1, further comprising:
providing the results of checking the target firewall policy to a user via a Graphic User Interface (GUI).

6. The method of claim 1, wherein the target firewall policy includes at least one of a start address, a destination address, a protocol, a port, and a policy.

7. An apparatus for checking a firewall policy, the apparatus comprising:
a firewall policy receiving unit that receives a target firewall policy;
a checking unit that checks for errors in the target firewall policy by comparing the target firewall policy with an existing firewall policy applied to an existing firewall system; and
a check result output unit that outputs the results of the checking unit.

8. The apparatus of claim 7, wherein the firewall policy receiving unit periodically receives the target firewall policy from the existing firewall system.

9. The apparatus of claim 7, wherein the firewall policy receiving unit receives the target firewall policy from a user.

10. The apparatus of claim 7, wherein the checking unit includes a simulation module that simulates a state in which the target firewall policy is applied to a new firewall system, in order to check for errors in the target firewall policy when the target firewall policy is for the new firewall system.

11. The apparatus of claim 7, wherein the checking unit includes a parsing module that parses the target firewall policy to convert it into a form that can be compared with the existing firewall policy, when the target firewall policy is for an existing firewall system.

12. The apparatus of claim 7, wherein the check result output unit outputs the results of checking the target firewall policy to a user through a GUI.

13. The apparatus of claim 7, wherein the target firewall policy includes at least one of a start address, a destination address, a protocol, a port, and a policy.

14. The apparatus of claim 7, wherein the apparatus is installed at a position that is physically separated from the existing firewall system.
